(19) United States
(12) Patent Application Publication
(10) Pub. No.: US 2022/0027976 A1
(43) Pub. Date: Jan. 27, 2022

(54) DYNAMICALLY CREATING ELECTRONIC EVENTS BASED ON USER PRODUCT PREFERENCES AND IDENTIFIED USER LOCATION

(71) Applicant: Brad Sherp, Spring Hill, TN (US)

(72) Inventor: Brad Sherp, Spring Hill, TN (US)

(21) Appl. No.: 17/183,340

(22) Filed: Feb. 23, 2021

Related U.S. Application Data
(60) Provisional application No. 63/056,247, filed on Jul. 24, 2020.
(60) Provisional application No. 63/150,548, filed on Feb. 17, 2021.

(51) Int. Cl. G06Q 30/06; G06Q 30/02

(52) U.S. Cl. CPC G06Q 30/0631; G06Q 30/0282; G06Q 30/0643

(57) ABSTRACT

Methods, systems, and apparatus, including computer programs encoded on computer storage media for dynamically creating electronic events based on user product preferences and identified user location. The system determines a suggested product and displays a representation of the product including a graphical image of the suggested product and a description of the suggested product. The system includes functionality to indicate whether a first user account would like to try the suggested product. The system receives a user input selection for the first user account indicating a confirmation that the first user would like to try the suggested product. The system matches the first user account and a second user account for the suggested product where the respective user accounts include indications that both user accounts would like to try the suggested product.

### CROSS-REFERENCE TO RELATED APPLICATIONS

This application claims the benefit of U.S. Provisional Application No. 63/056247, filed Jul. 24, 2020, which is hereby incorporated by reference in its entirety. This application also claims the benefit of U.S. Provisional Application No. 63/150,548, filed Feb. 17, 2021, which is hereby incorporated by reference in its entirety.

### BACKGROUND

Ratings or reviews of products or services provide consumers important reference to gauge the quality of the product or service. Often times, however, these ratings may not accurately reflect a true rating for the product or service. In many instances, fake ratings are provided to increase the overall ratings. A user can not trust the actual rating values for the product or service. As such, a new inventive rating system is needed to provide a more authentic rating that a user may trust and rely upon to make purchasing decisions.

### SUMMARY

Described herein is an innovative system and methods directed toward product and service review ratings. In one embodiment, methods, systems, and apparatus, include computer programs encoded on computer storage media provide for product review ratings via multiple user accounts. The system determines a first aggregate review rating for a product where the first aggregate review rating is based on a first group of multiple user accounts. The system determines a second aggregate review rating for the particular product based on a subset of a second group of multiple user accounts. The subset includes user accounts of the first group having a confirmed electronic connection with a primary user account. The system displays for the primary user account, via a user interface, the particular product having an indication of the first aggregate review rating and the second aggregate review rating of the subset of user accounts.

In another embodiment, methods, systems, and apparatus, include computer programs encoded on computer storage media provide for connection of user accounts based on whether a user account has an indication of whether the user would like to try a product. The system determines a suggested product based on a respective product located in a normalized electronic records database for display, via a user interface, for a first user account. The system displays, via the user interface, a representation of the suggested product where the representation includes a graphical image of the suggested product and a normalized description of the suggested product. The system displays, via the user interface, a selectable functionality to indicate whether the first user account would like to try the suggested product. The system receives, via the user interface, a user input selection for the first user account indicating a confirmation that the first user would like to try the suggested product. The system matches the first user account and a second user account for the suggested product where both user accounts include indications that the respective user accounts would like to try the suggested product. The system displays, via the user interface, for the first user account an indication that a second user account would also like to try the suggested product.

In another embodiment, methods, systems, and apparatus, include computer programs encoded on computer storage media provide for creating an eating event for two or more users based on a user indication captured by the system of whether a user would like to try a particular product (such as a menu item), and/or based on a user rating for the particular product. The system provides for a user interface that presents functionality for the user to create and schedule an event where the user creating the event and another user would meet at a location to try the particular product. The system includes functionality to automatically suggest or identify other users of the system where the other users have indicated that the other user would like to try the menu item. The system may generate the listing of the other users to the primary user creating an eating event. The primary user may then invite the listed users to eating event. The system may further limit the listing of the other users based on a geographic region of the primary user and the other users residential address (that has been stored by the system), and based on the location of the store or restaurant where the particular product is to be tried.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 illustrates a diagram of an example system utilized in product and service review ratings.

FIG. 2 illustrates an example of an overview of a process for user account review for products.

FIG. 3 illustrates an example of an overview of a process for user account connection for products.

FIG. 4 illustrates an example of an overview of a process for product name normalization.

FIG. 5A illustrates an example user interface according to one embodiment of the present disclosure.

FIG. 5B illustrates an example user interface according to one embodiment of the present disclosure.

FIG. 6 illustrates an example user interface according to one embodiment of the present disclosure.

FIG. 7A illustrates an example user interface according to one embodiment of the present disclosure.

FIG. 7B illustrates continuation of the example user interface according to the embodiment of FIG. 7A.

FIG. 8A illustrates an example user interface according to one embodiment of the present disclosure.

FIG. 8B illustrates an example user interface according to one embodiment of the present disclosure.

FIG. 9A illustrates an example user interface according to one embodiment of the present disclosure.

FIG. 9B illustrates an example user interface according to one embodiment of the present disclosure.

FIG. 10 illustrates an example user interface according to one embodiment of the present disclosure.

FIG. 11 illustrates an example user interface according to one embodiment of the present disclosure.

FIG. 12 illustrates an example user interface according to one embodiment of the present disclosure.

FIG. 13 illustrates an example user interface according to one embodiment of the present disclosure.

FIG. 14 illustrates an example user interface according to one embodiment of the present disclosure.

FIG. 15 illustrates an example user interface according to one embodiment of the present disclosure.

FIG. 16 illustrates an example user interface according to one embodiment of the present disclosure.

FIG. 17 illustrates an example user interface according to one embodiment of the present disclosure.

FIG. 18 illustrates a diagram of an exemplary environment in which some embodiments may operate.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

### Example System Diagram

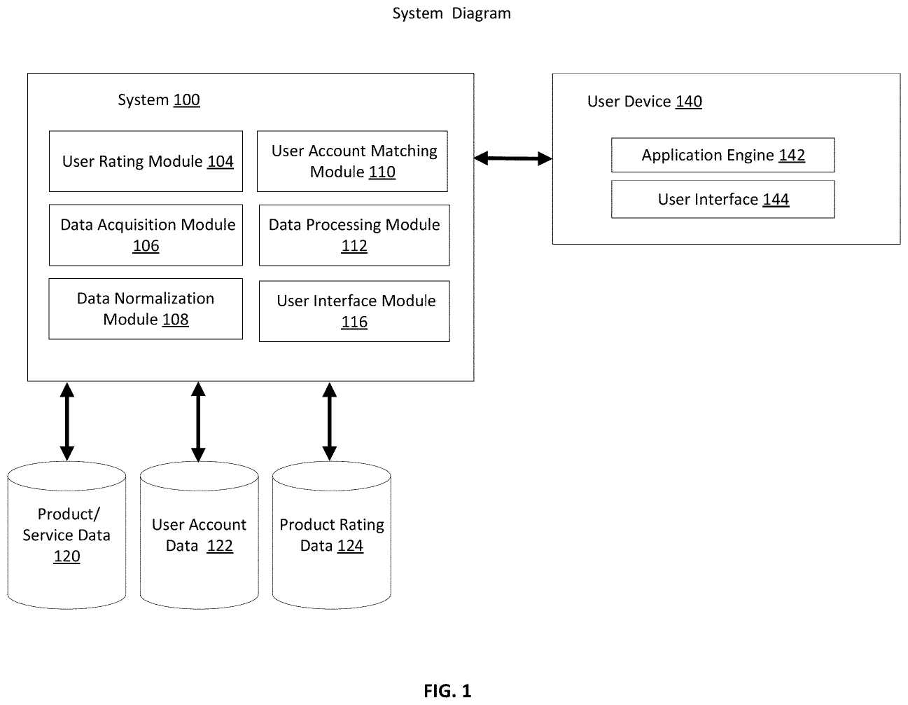

FIG. 1 illustrates a diagram of an example system 100 utilized in product and service review ratings. The system 100 may include a User Rating 104, a Data Acquisition Module 106, a Data Normalization Module 108, a User Account Match Module 110, a Data Processing Module 112 and a User Interface Module 116.

While the databases 120, 122, 124, 126 are displayed separately, the databases and information maintained in a database 120, 122, 124, 126 may be combined together or further separated in a manner that promotes retrieval and storage efficiency and/or data security. The databases may include information related to product and/or service data 120, user account data 122 and product rating data 124.

The User Rating Module 104 may perform functionality related to a determining aggregate rating values for a product.

The Data Acquisition Module 106 may perform functionality related to handling communication and receipt and transfer of data received by the system via user interfaces, and for obtaining data from websites.

The Data Normalization Module 108 may perform functionality related to normalizing disparate data obtained from websites, where the data describes different products or services.

The User Account Matching Module 110 may perform functionality related to matching user accounts where the user accounts have indicated that they would like to try a particular product or service.

The Data Processing Module 112 may perform functionality related to additional processing of data (such as ratings) related to products or services.

The User Interface Module 116 may perform functionality related to rendering and display of information as described herein.

The User Device 140 may have an Application Engine 142 and a User Interface 144. It is understood that the system 100 may further include one or more additional modules for performing, or supporting performance of, any operation(s), step(s), act(s), instruction(s) and process(es) described herein.

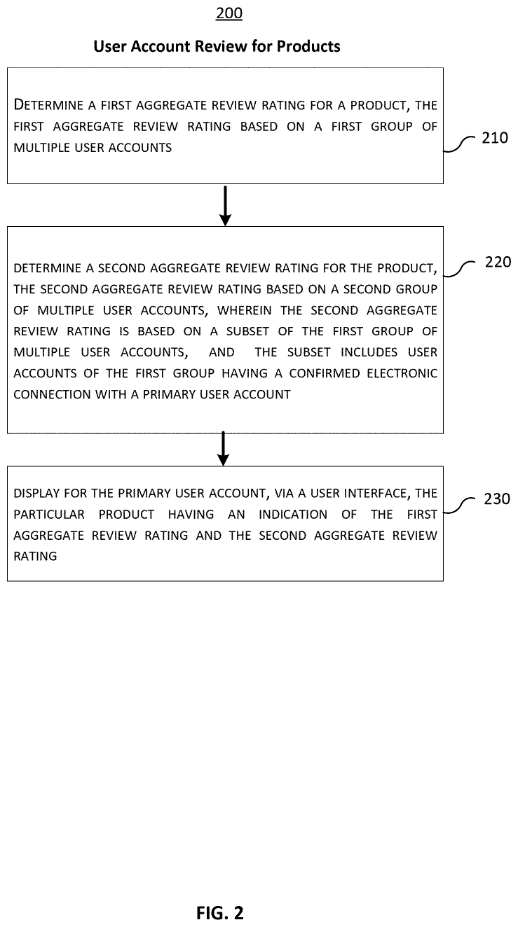

FIG. 2 illustrates an example of an overview of a process for user account review for products. The system 100 provides a software platform for tracking and managing user account reviews for products and/or services. As will be described with the example user interfaces, a product is that of menu items offered by restaurants. Referring to FIG. 2, an example process for user account review of products is described. The system 100 via the data processing module 112 obtains product or service ratings from the product rating data database 124. The system 100 determines a first aggregate review rating for a product where the first aggregate review rating is based on a first group of multiple user accounts (step 210). For example, multiple users have provided a review rating for a particular product or service, and the rating information is stored in the product rating data database 124. The first aggregate review rating may be an average value calculated by the data processing module 112 for ratings provided by the multiple users. For example, the storage rating values may be in a range 0-5, or 0-10, or some other type of scale.

The system 100 determines a second aggregate review rating for the product where the second aggregate review rating is based on a second group of multiple user accounts (step 220). The second aggregate review rating is based on a subset of the first group of multiple user accounts, and the subset includes user accounts of the first group having a confirmed electronic connection with a primary user account. For example, the second group of user accounts are user accounts that are a subset of the multiple user accounts, and where there is a social connection with the primary user account. The second aggregate review rating may be an average value calculated by the data processing module 112 for the ratings provided by the second group of user accounts.

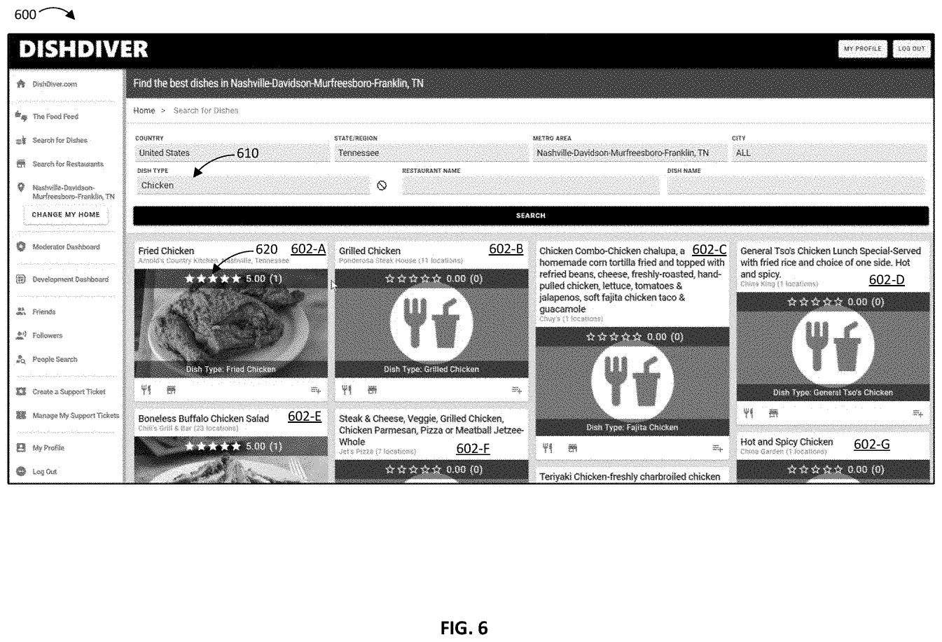

The system 100, via the User Interface Module 116, provides information related to the first aggregate review rating and the second aggregate review rating to the Application Engine 142. For the primary user account, the user interface 144 displays the particular product having an indication of the first aggregate review rating and the second aggregate review rating (step 230). The first and second aggregate review ratings will be further described in reference to the example user interfaces as depicted in FIGS. 6, 7A, 9A and 9B.

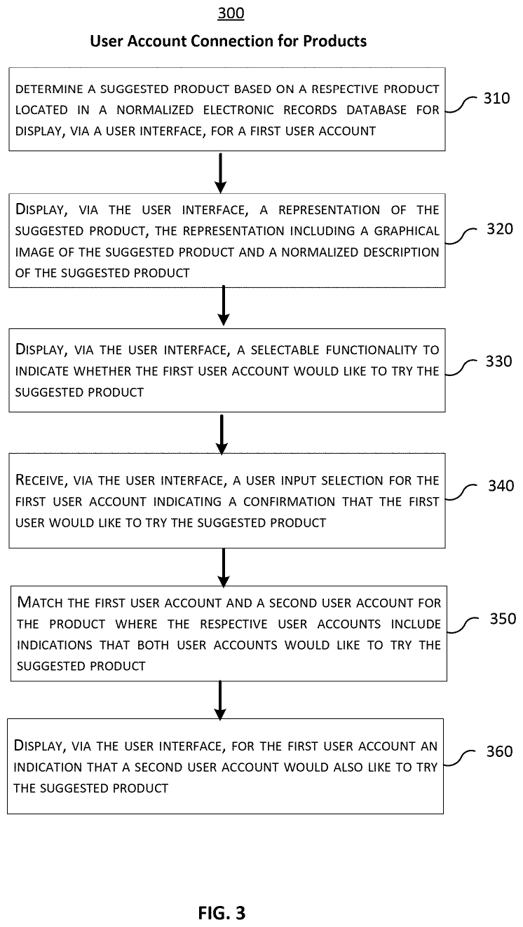

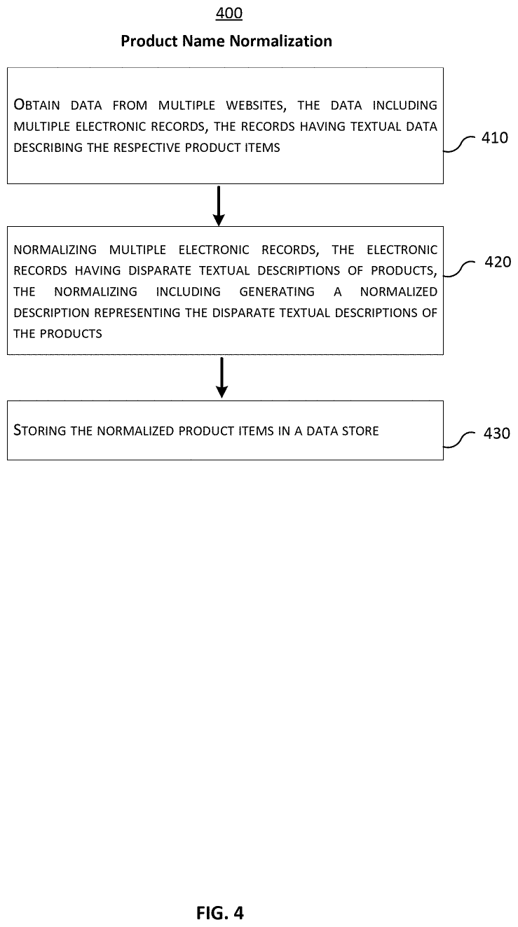

FIG. 3 illustrates an example of an overview of a process for user account connection for products. The system 100 provides functionality for connecting user accounts based on preferences and indications of whether a respective user account would like to try a product or service. The system 100 matches user accounts where the users have previously indicated that they would like to try the same product or service. The system 100 determines a suggested product based on a respective product located in a normalized electronic records database for display, via a user interface 144, for a first user account (step 310). Generation of the normalized products data is described below with regard to FIG. 4. The suggested product may be determined based on a user product profile indicating the type of product that user would like to try. The Data Processing Module 112 may determine a product to suggest to a particular user based on their preferences. For example, in the context of a menu item as a product, the system 100 may suggest a menu item that the user has not tried, based on the type of other menu items that the user has tried, based on a geographic location of the restaurant to a determined location value for a user, and/or based on other suggestion factors.

The system 100 displays, via the user interface 144, a representation of the suggested product, the representation may include a graphical image of the suggested product and/or a normalized textual description of the suggested product (step 320). The system 100 also displays, via the user interface 144, a selectable functionality to indicate whether the first user account would like to try the suggested product (step 330). The system 100 receives, via the user interface, a user input selection for the first user account indicating a confirmation that the first user would like to try the suggested product (step 340). Via the User Account Matching Module 110, the system 100 matches a first user account and a second user account for the product where the respective user accounts include indications that both user accounts would like to try the suggested product (350). The system 100 displays, via the user interface 144, for the first user account an indication that a second user account would also like to try the suggested product (step 360).

FIG. 4 illustrates an example of an overview of a process for product name normalization. The system 100 may obtain data for a disparate set of product items. For restaurants that offer different menu items, the system 100, using the Data Normalization Module 108, may normalize different menu items to provide a normalized category for the menu item. Each of the menu items may then be later search on a term or word that is associated to multiple menu items.

The Data Acquisition Module 106 may obtain data from multiple websites where the data includes multiple electronic records having textual data describing the respective product items step 410). The Data Normalization Module may process the obtained data and generate normalized terms or words that are associated to the disparate data records (step 420). The normalized terms or words are stored in a database that may then be used by the system to search for particular products based on the normalized terms or words.

The system 100 may obtain data from websites related to products and services being offered by a particular company or restaurant. The system 100 then creates a common taxonomy or words that are related to the products and services. For example, the system normalizes multiple electronic records where the electronic records having disparate textual descriptions of a group of products. The data normalization process includes generating a normalized description for the particular product representing the disparate textual descriptions for the group of products.

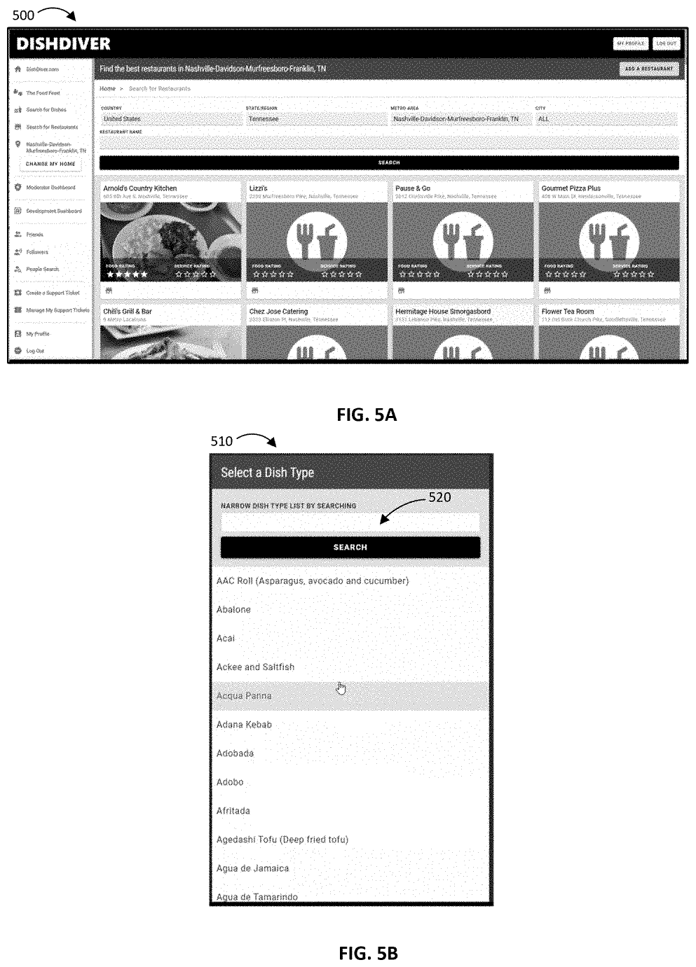

Referring now to example user interfaces, the example processes as described above, will be further explored. FIG. 5A illustrates an example user interface 500 according to one embodiment of the present disclosure. The user interface 500 may display information related to one or more product or services. In this example, the user interface 500 display menu items for different restaurants and may include the name and location of the restaurant. The user interface may display an image of the menu item and an aggregate rating based on different rating criteria. In the example, the user interface displays an aggregate rating for Food Rating and Service Rating. The Food Rating and Aggregate rating may be determined by the system 100 based on multiple user accounts that have rated the particular menu item on the respective rating criteria.

FIG. 5B illustrates an example user interface 510 according to one embodiment of the present disclosure. The user interface may receive a user selection to Search for Dishes which would provide a user interface 510 to search or narrow the restaurants and food items displayed in the user interface 500. User interface 510 allows user to input search terms and/or select from a listing of terms. The system 100 uses the search terms to search the normalized data to find menu items that are associated with the search term. A resulting list of restaurants having the particular menu items would then be presented via the user interface as is further described with regard to FIG. 6.

FIG. 6 illustrates an example user interface 600 according to one embodiment of the present disclosure. In the example, the user interface 600 depicts a dish type of “Chicken” that was searched for via user interface 510 of FIG. 5B. As shown in FIG. 6, the user interface displays various menu items related to the normalized term “Chicken”. The term “Chicken” was normalized and associated to with the menu item descriptions of “Fried Chicken” 602-A, “Grilled Chicken” 602-B, “Chicken Combo-Chicken chalupa” 602-C, “General Tso's Chicken” 602-D, “Boneless Buffalo Chicken Salad” 602-E, “Steak & Cheese, Veggie, Grilled Chicken, Chicken Parmesan” 602-F, “Hot and Spicy Chicken” 602-G, etc. The user interface 600 may display an aggregate user account rating 620. This rating may be displayed as a graphical indication such a series of icons representing the scale of the rating. Additionally, the number of user accounts rating the dish item may be displayed next to the rating. A user may select the particular menu item, and in response the system will display a detailed user interface view of the menu item. For example, if a user selects the menu item for “Fried Chicken” 620, the user interface of 7A may be displayed.

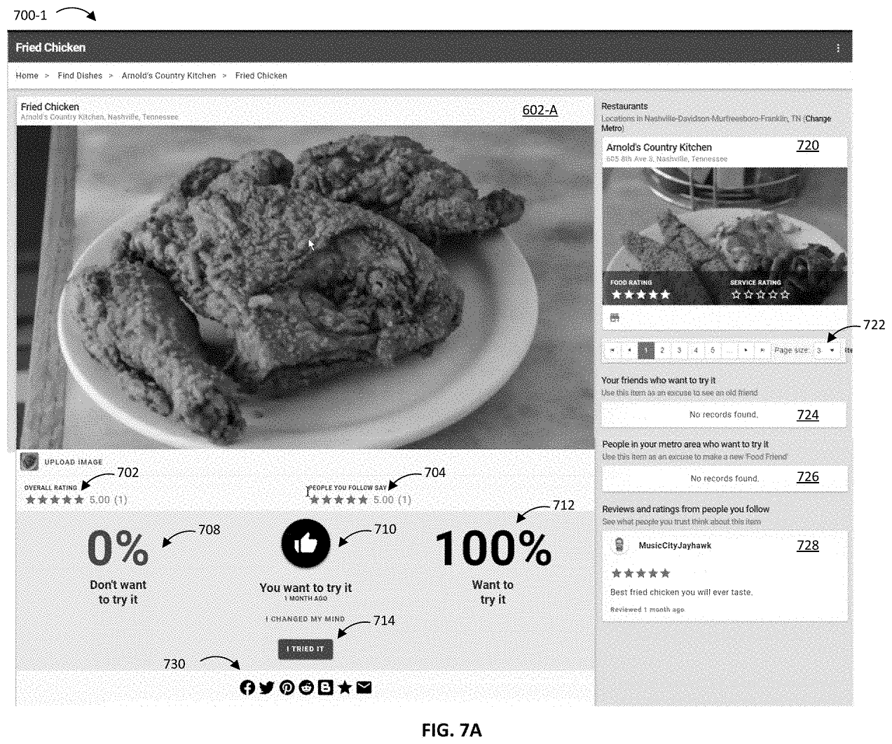

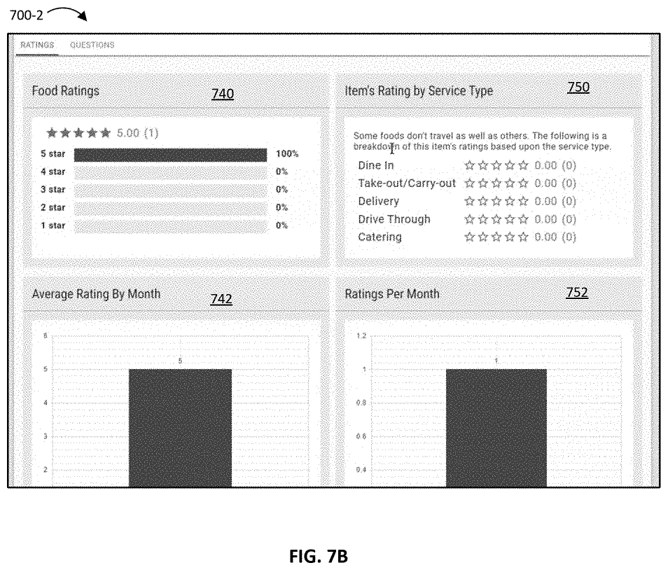

FIG. 7A illustrates an example user interface 700-1 according to one embodiment of the present disclosure. The system may generate user interface 700-1 which may display additional detailed information about the menu item, aggregate user account reviews of the menu items 702, 704, percentages of user accounts that want to try the menu item 708 and those user accounts that do not 712. Also, the menu item may be shared via social media by a user selection the respective social media icon 730.

The user interface 700-1 also may display an icon, button or other graphical indicator where a user may select on the graphical indicator 710 to note whether the user would like to try the menu item. The system 100, upon receiving the user account input, would then update the user account records to indicate that the user would like to try the menu item.

The user interface 700-1 also may display an icon, button or other graphical indicator where a user may select on the graphical indicator 714 to note whether the user had actually tried the menu item. The system 100, upon receiving the user account input noting the user has tried the item would then update the user account records to indicate that the user has tried the menu item. The user interface 700-1 also provides a “upload image” option where an image of the respective product may be uploaded and stored in a database for the particular item. For example, a user may take a picture of menu item they had ordered, and the upload the image of the menu item via the system. Additionally, the system 100 may obtain location information from the image itself, or request location data from the mobile device. The system 100 may confirm whether or not the image location matches the location of the particular restaurant where the image should have been taken. If the image location does not match the location of the restaurant, then the system 100 may disallow or not let the image of the item be stored on the system 100 or may not allow the image to be associated with a particular review. For example, a user may take a picture while dining in at a restaurant. The mobile device may associate a location of where the image was taken (such as a GPS location or other geo-spatial coordinates). The system 100 may compare the image location with a geofence or other geospatial boundary associated with the restaurant. If the image location is determined to be located within the geospatial boundary of the restaurant, the system 100 would allow uploading of the image. If the image location does not fall within the geospatial boundary, then the system 100 may not allow the uploading of the image.

As discussed previously with regard to FIG. 2, the user interface 700-1 may display a first aggregate rating 702 (e.g., an overall rating) and a second aggregate rating 704 (e.g., a rating for what people you follow say). The first aggregate rating 702 is based on a rating of multiple user accounts that have rated the menu item. The second aggregate rating 704 is based on a rate of a subset of the multiple user accounts where the primary user account (i.e., the user reviewing the menu item via the user interface 700-1) has an established electronic connection with the one or more users accounts that are part of the first aggregate rating. This functionality allows a user to see an overall product rating by a general population of user accounts, and then also see a product rating based on those user accounts (i.e., connected friends, family, influencers, food critics, etc.). The second aggregate rating 704 provides a realistic or trusted rating based on ratings that other user accounts have provided where the primary account is associated to. In other words, the primary account user may not know or have any reason to trust all of the users that have provided a rating. In some instances an overall rating 702 may be very high (possibly due to multiple fake ratings to boost the rating scores), whereas the rating by users the primary user account follows may be actually really. Also, the first aggregate rating 702 may be very low, whereas the second aggregate rating 704 may be very high.

Additionally, the user interface 700-1 may display other food items 720 that the particular restaurant may serve. A user may then navigate via the navigation control 722 to display details about other food items (e.g., products) that the restaurant offers. In response to a selection of another food item, the system 100 would update user the interface 700-1 with relevant details about the new food item.

Additionally, the user interface 700-1 may display other information about other user accounts that have created an association with the food item. For example, the user interface 700-1 may display in a portion of the user interface 724 user accounts of friends (i.e., connected user accounts with the primary user account) that have indicated that they want to try the menu item. Additionally, the user interface 700-1 may display in a portion of the user interface 726 user accounts of people (i.e., non-connected user accounts) in a geographic area that is proximate to a location of the primary user account. Also, the user interface 700-1 may display in a portion of the user interface 728 user accounts of people that the primary user account follows.

FIG. 7B illustrates continuation of the example user interface 700-1 according to the embodiment of FIG. 7A. The user interface 700-2 may also display additional information as depicted in user interface portion 700-2. For example, the user interface 700-1 may display a scale or breakdown of the respective rates of user accounts 740. The user interface 700-2, may display a section of item's ratings by service type 750. The particular service type may be particular to the products/services offered by a company, restaurant or store. In this example, service types may include categories of “Dine In”, “Take-out/Carry-out”, “Delivery”, “Drive Through” and/or “Catering”. Other information that may be displayed include a graphical indication of average rating by month 742 and ratings by month 752.

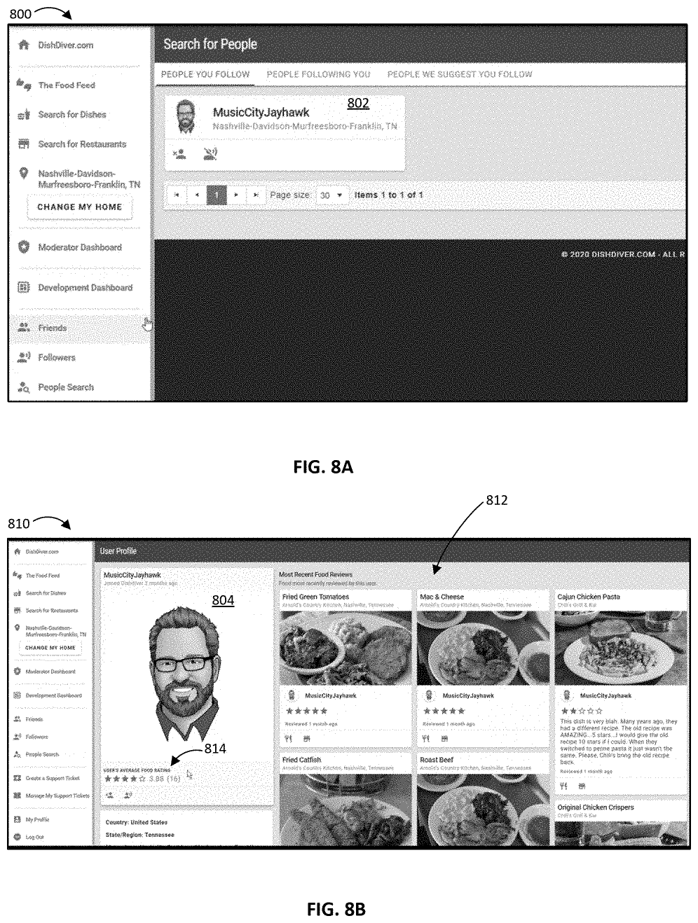

FIG. 8A illustrates an example user interface 800 according to one embodiment of the present disclosure. The user interface 800 allows for searching and/or browsing for other user accounts. For example, user interface 800 depicts a user account 802 being followed by the primary user account. The user interface 800 provides for searching/browsing of user accounts of other user being followed, user accounts following the primary user accounts, and suggestions of users accounts that the primary user account may be interested in following.

FIG. 8B illustrates an example user interface 810 according to one embodiment of the present disclosure. The user interface 810 is an example of a user account and menu items 812 that the user account has rated. In this example the user account 804 is one that the primary user account is following. The system may determine the user account's average rating for a product. For example, the user's average food rating 814 is depicted with a series of icons representing the scale of the ratings (e.g., “3.88”), and the number of ratings (e.g., 16). The user interface 810 may display the respective menu items rated by the user showing the user's rating for the menu item.

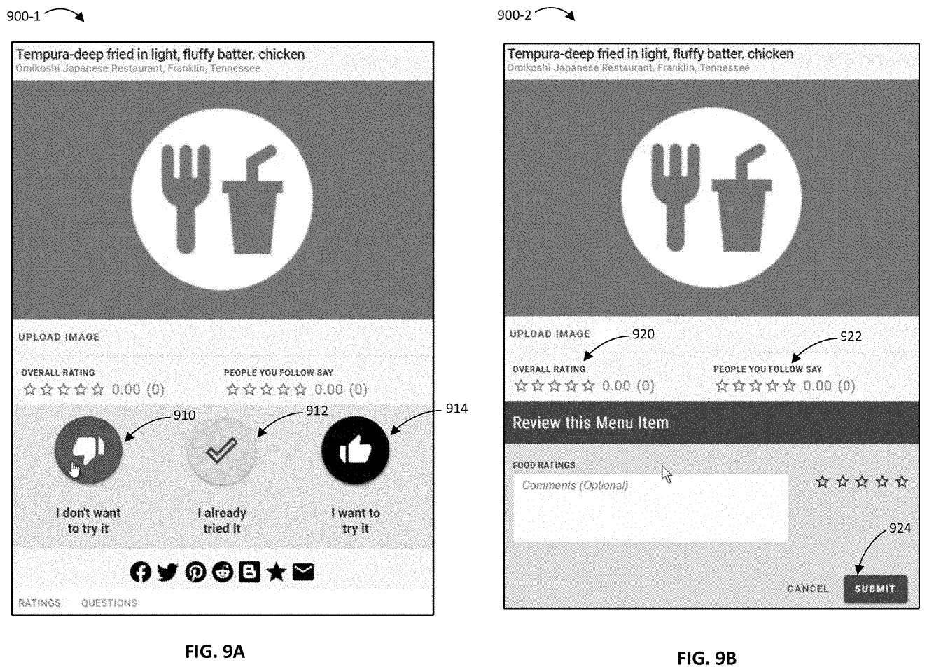

FIGS. 9A and 9B illustrates an example user interface 900-1, 900-2 according to one embodiment of the present disclosure. The system 100 may generate a user interface 900-1 for a primary user account to rate a particular product or service. In this example, the user interface 900-1 allows a user to indicate that they don't want to try the item 910, that they have already tried the item 912, or that they want to try the item. The system 100 receives the user input for the particular food item and stores in a database the user's preference for the food item. Also, comments may be added as to the food item and user ratings may be submitted via the submission button 924. The system 100 may store the selection selections of the user on the databases 122 and 124. Additionally, the system 100 may be configured that the interface 900-1 only allows the user to choose from one of the selections 910, 912, 914. When the user interface 900-1 receives an input selecting one of the items 910, 912 or 914, in response then the non-selected items may be displayed in a non-high-lighted, grayed out, or some other indication to show that the items were not selected. The selected item may be displayed in highlighted or other graphical manner to indicate the selection of the item.

Moreover, the user interface 900-1 display the first aggregate rating 920 (e.g., “Overall Rating”), of other others and the second aggregate rating 922 (e.g., “People You Follow Say”) of those user accounts where the primary user account has an established electronic connection with another user account. For example, an established electronic connection with another user account may be where a second user account has accepted an invite from the first user account to establish a connection.

The user interface 900-2 also provides a “upload image” option where an image of the respective product may be uploaded and stored in a database for the particular item. For example, a user may take a picture of menu item they had ordered, and the upload the image of the menu item via the system. Additionally, the system 100 may obtain location information from the image itself, or request location data from the mobile device. The system 100 may confirm whether or not the image location matches the location of the particular restaurant where the image should have been taken. If the image location does not match the location of the restaurant, then the system 100 may disallow or not let the image of the item be stored on the system 100 or may not allow the image to be associated with a particular review. For example, a user may take a picture while dining in at a restaurant. The mobile device may associate a location of where the image was taken (such as a GPS location or other geo-spatial coordinates). The system 100 may compare the image location with a geofence or other geospatial boundary associated with the restaurant. If the image location is determined to be located within the geospatial boundary of the restaurant, the system 100 would allow uploading of the image. If the image location does not fall within the geospatial boundary, then the system 100 may not allow the uploading of the image.

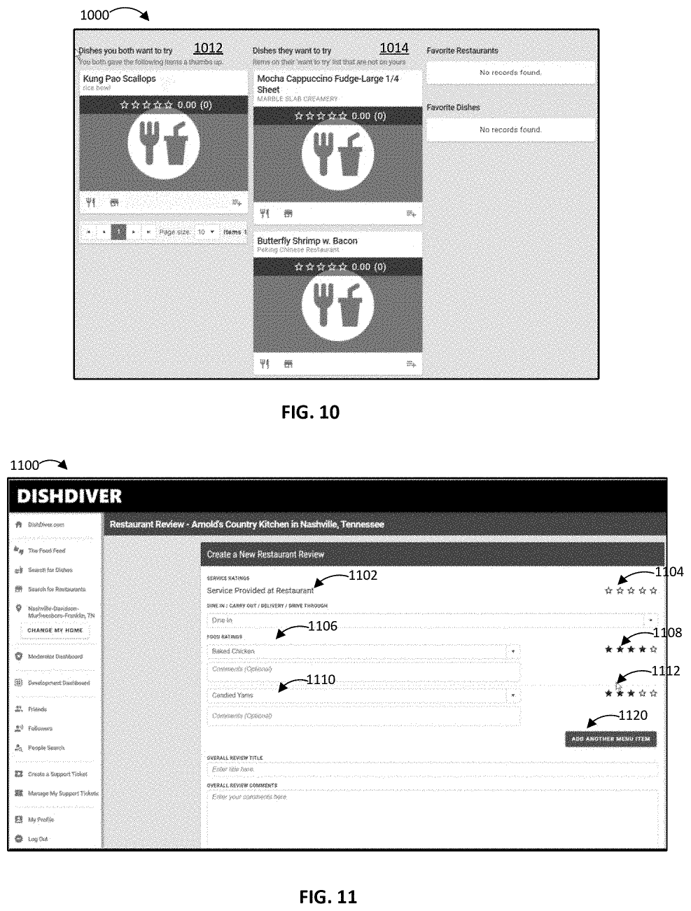

FIG. 10 illustrates an example user interface 1000 according to one embodiment of the present disclosure. The primary user account may select another user account to see what menu items that other user account would like to try. As described above, the system 100 may receive user input about a particular menu item (e.g., product or service) that the user account would like to try. The system 100 may determine which menu item a particular user would like to try by retrieving from the user account data database 122 the stored indication for a particular menu item of whether or not the user account has indicated if they would like to try the menu item. The system 100 may perform a query to determine which menu items both the primary user account and another user account would like to try.

The system 100 may generate a user interface 1000 where the user interface displays in a portion 1012 of the user interface menu items (e.g., with menu item information such an image of the menu items, ratings of the menu item and/or textual description of the menu item) where the primary user account and another user account both want to tray the menu item. As used herein the word menu items refers to food items that are offered by restaurant. The user interface 1000 may also display via a user interface portion 1014 those menu items where the other user account would like to try a menu item where the primary user account has not yet indicated that they would also like to try the menu time. If the other user account had stored a favorite restaurant and/or a favorite dish, then that information would also be displayed via the user interface 1000.

FIG. 11 illustrates an example user interface 1100 according to one embodiment of the present disclosure. This example user interface 1100 provides functionality where the primary user account may provide review information about a menu item. For example, the system 100 may receive user input about the service of a restaurant (e.g., by selecting value for a graphical-based rating scale). The rating scale value may be stored on a database with regards to the service and in association with the primary user account. The category of service may be selected from a drop-down listbox for the service types (e.g., “Dine In”, “Carry Out”, “Delivery”, “Drive Through”).

The user interface 1100 allows for the rating of particular menu items 1106 via the rating scale 1108. The primary user account may add multiple items for review via the add menu item button 1120. The system 100 may retrieve from the database those menu or food items that are associated with the particular restaurant for which the review is being made. The user interface 1100 may also receive comments per menu time, an overall review title, and overall review comments. The system 100 stores the input received via the user interface 1100.

The system 100 may store on the product rating database 124 a rating value associated to a particular user account id and a particular product id. For example, the database may store in data field of data records a unique identifier for a user account representing a particular user, a particular product id representing a product being rated, and then a rating value corresponding to the rating provided by the user. Additionally, the product rating database 124 may store with the data record a field describing the category of the service type.

Restaurant Matching and Scheduling

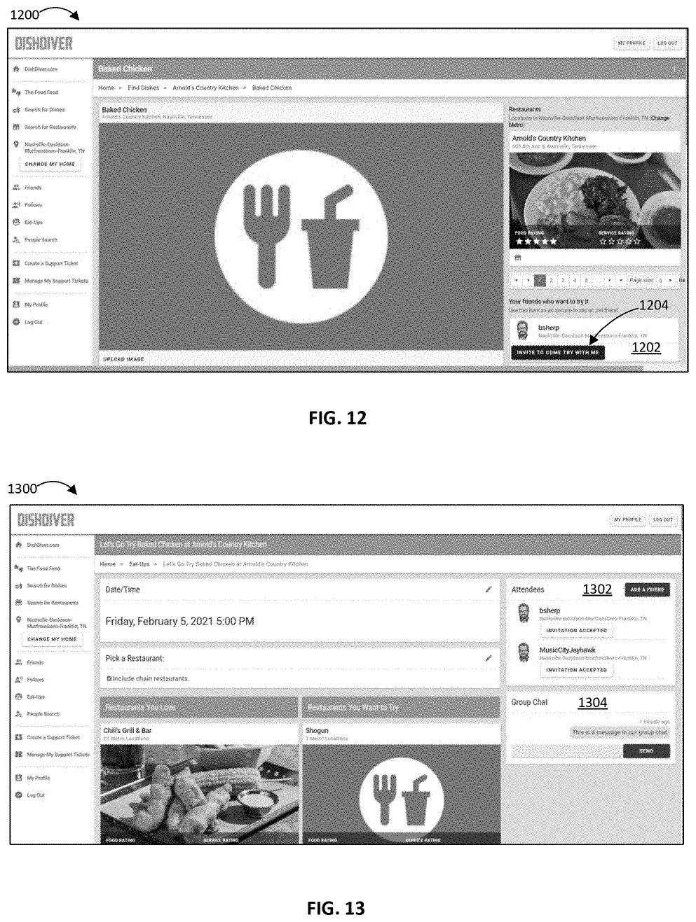

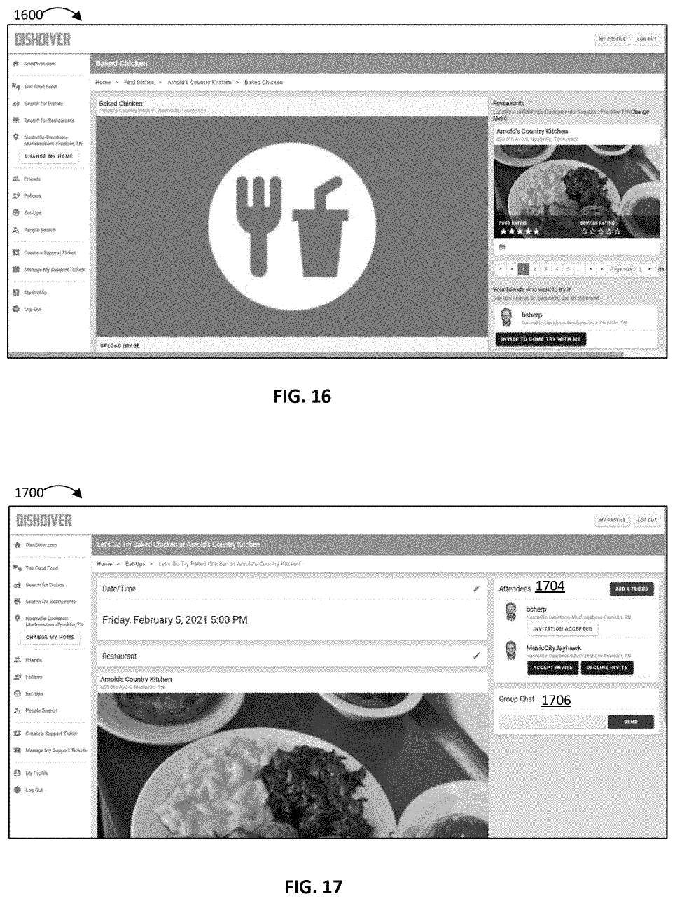

Referring to FIGS. 12-17, the figures illustrate example user interface allowing a user to create, schedule and manage an eating event with another user of the system 100. The User Account Matching Module 110 provides functionality for proposing an event for potential restaurants of interest for two or more users. The system allows for a user to create an eating event (also referred to as an “eat-up”), and the system suggests one or more restaurants based on a user preference as to a particular menu item or a restaurant.

Referring to FIG. 12, the user interface 1200 depicts a section 1202 that lists those users that have indicated they would like to try the menu item as the primary user. The system 100 may search for other users, such as other users connected with the primary user as a friend, and list those user in section 1202. The user interface 1200 may receive a selection, via the user affordance 1204, by the primary user to invite a listed user to try the menu item with the primary user.

Referring to FIG. 13, the user interface 1300 displays a section 1302 indicating the acceptance status of an invitation to an eating event. The user interface 1300 illustrates that the invitation to the eating event has been accepted by two users. The user interface 1300 also provides a chat window 1304 to provide electronic messaging among the attendees to the eating event.

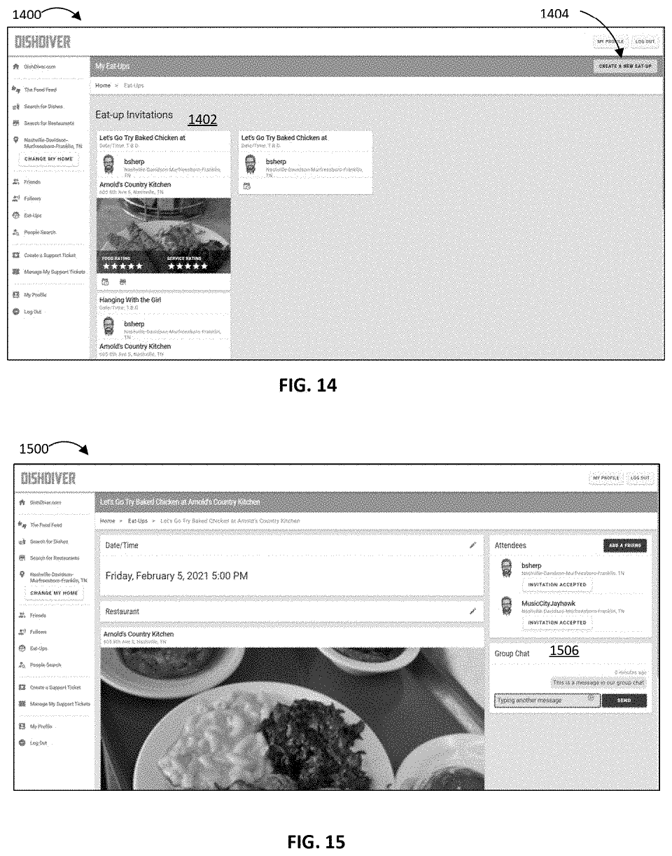

For example, the system 100 may present the user interface 1400 of FIG. 14. The user interface 1400 displays eating event invitations that have been sent to other users of the system. The user interface 1400 includes a graphical user affordance 1404 where a user may create a new eating event. The user interface 1400 includes a section 1402 where the eating events may be displayed. The eating events include may include a generated title based on a menu item of a particular restaurant. For example, when the eating event is created the system may use a name of a menu item to create the title, such as “Let's Go Try Baked Chicken at” where “Baked Chicken” is the name of the menu item to be tried with another user. The section 1402 may include the name of the restaurant, an image of the menu item (e.g. product) to be tried, and a food and/or service rating.

The system 100, may present the user interface 1500 of FIG. 15. The user interface 1500 displays further detail of an eating event of FIG. 14. For example, a user may select the select an eating event in the user interface 1400, which then displays the user interface 1500 which depicts further details of the eating event. For example, the user interface 1500 may include a section 1502 to display the date and time of the event.

The user interface 1500 may include a section 1504 to display the status of the invited users to the eating event. For example, section 1504 may display the listing of users invited to the event and an acceptance status of whether or not a particular listed use has accepted the eating event. The section 1504 may also include a graphical user affordance to “Add a Friend”. In response to receiving a selection of the “Add a Friend” button, the system would provide a search user interface to search and find other system users to invite to the planned eating event. For individuals, who are not already users of the system 100, a person may be invited to the eating event via an email address and/or a phone number. The system 100 will generate a link with details about the eating event and send the link to those individuals.

The user interface 1500 may include a group chat section 1560 this allows, the invitees to an eating event to easily communication to one another. For example, a user may enter a message into the group chat section 1506. In response to receiving, an input to send an input message, the system will then send to the other invitees the message.

Referring to FIG. 17, the user interface 1700 further illustrates an example where a user is presented with an option to accept or decline the eating event. For example, in section 1704 the user “MusiCityJayhawk” is present an option to accept an invite or decline an invite. The system upon receiving an input to accept or decline an eating event, will then update the system with the respective users invite preference. Each of the other users invited to an eating event, are able to se the status of other users in the Attendees section 1704 (and 1504 as discussed above).

The process of creating an event may be further illustrated with an example process of creating an eating event and inviting one or more users to the eating event. The process may begin with displaying a user interface, via the system, where the user interface receives a user input or selection to create an eating event. The eating event has a particular location for a restaurant or store, a product to be tried together by two or more users (e.g., a menu item), and a prospective date/time for when the eating event is to occur. The system 100 provides a user interface where a primary user may select a menu item of a restaurant for the eating event. The system 100 may automatically suggest an eating event based on a preference of the primary user creating the eating event and/or a preference of another user. The preferences of the users are retrievable by the system 100 from the database User Account Data 122 and/or Product Rating Data 124. For example, as discussed above users of the system 100 may already identified a particular menu item (e.g., a product) that they would like to try. The system 100 would have stored the indication for the respective users that they want to try the particular menu item.

The system 100 may then determine a menu item of a restaurant for the eating event based on the designation that a user would like to try the menu item. Furthermore, the system 100 may determine a geographic area of the primary user creating the eating event and one or more other uses with a geographic area. For example, a geographic area may include a zip code, metropolitan area, city or other geographic zone. The system 100 may determine those users that are within the geographic area, and identify whether there is a match of a particular menu item that users have identified that they would like to try. The system 100 may present via a user interface the menu items and information about the users that would like to try the menu item. The system 100 may present only those users that would like to try the same menu item, but being further limited to only those users having an established friend connection with one another.

Furthermore, the system 100 may utilize a menu item suggestion engine that evaluates and identifies those menu items that a user would like to try or those menu items that a user has already tried. This data is stored in the User Account Data database 122 and/or the Product Rating Data database 124. The suggestion engine may evaluate and identify (i) those users that have indicated that they would like to try a menu item, and (ii) those users that have indicated they have tried the menu item and have provided a rating for the menu item. The system 100 may exclude those menu items where a user has indicated that have tried a menu item, but the rating for the menu item is below a threshold. For example, the system 100 may identify that a user has tried a menu item but has given the menu item a rating of 2 (on a scale of 1-5). The system 100 may use a filtering process to exclude those menu item below a threshold number such as a value of 4 in this instance. When suggesting a menu item then, this allows the system 100 to identify only those menu items where a user has tried the menu item, and has indicated a favorable rating for the menu item. In other words, the system 100, for a menu item suggestion, would not present those menu items where a user has indicated that they did not like the menu item based on their previous rating.

The system 100 may also generate matches for those users that are not already connected as friends. The friend connection status may be stored in the User Account Data database 122. The database 122 stored information indication which user has a friend connection with another user. This functionality allows a user to set up a meeting event with another user that they may not know personally. For example, the system 100 may include a user interface that accepts filtering parameters, such as demographic information, an age range, gender, interests, hobbies, school being attended or other data. The system 100 may perform a matching process to identify for a particular geographic area those users that would like to try a particular menu item. This matching process results in a data list of those users that would like to try the menu item, and that are within the particular geographic area. The system 100 may further filter the data list where there is a match of one or more of the filtering parameters. The system 100 may present, via a user interface, a listing of those matching users that would like to try the same menu item and meet the filtering parameters. The primary user may then invite, via the user interface, one or more of the other users that have been listed. This functionality provides a process by which users may meet new users that have identified that they would like to try a particular menu item, but are not yet connected as friends.

Moreover, the system 100 may allow the invitation of other users that are not identified as having already identified that they would like to try the menu item. The system 100 provides functionality to invite other user that are not identified in the listing of user that would like to try the menu item. For example, this functionality allows at least a group of two or more people to participate in the eating event for a menu item they both would like to try, but also allows any user invited to the eating event to invite other users to the event.

The system 100 may automatically suggest eating events for system users. For example, the system 100 may determine that a user has provided a particular rating for a menu item where the rating is above a threshold value (such as 4 or higher, on a scale of 1-5). This data for example, may be stored in the Product Rating Data database 124. The system 100 may determine that the user created the rating on a particular date. The high rating of ‘4’ indicates that the user may have really enjoyed the menu item. The system 100 may search for those ratings that are above a threshold rating value, and were created beyond a predetermined period of time, such as 4 months from the then current date and the date when the user created the rating for the menu item. For those, menu items meeting the criteria, the system 100 may suggest to the user, via a user interface, an eating event for the menu item at the particular restaurant where the menu item is offered. Additionally, the system 100 may identify other users as described herein that would like to try the menu item as indicated by the system, or have provided, via the system 100, and a rating of the menu item that similarly is above the threshold value for the user creating an eating event.

The system 100 presents in a user interface, graphical user interface elements, where the system may receive a user input of for the selection of a date and time for the eating event. The system 100 sends an invitation to one or more users of the system, and/or non-users of the system via electronic means, such as email or text messaging. The system 100 displays a user interface where those users may input a selection of either accepting or declining the eating event. The system 100 displays a user interface for those users invited to an eating event a listing of each of the users invited to the eating event and their respective acceptance status (such accepted, not accepted, or waiting for a decision). A user may change their acceptance status after inputting their selection.

The system 100 further provides a chat section in a user interface where those users that have been invited to the eating event (including the originating user of the eating event) may communication in a chat window. This allows the users to communicate further details about the event to one another. The system 100 stores in a database the communication details received in the chat window.

### Example Computer System

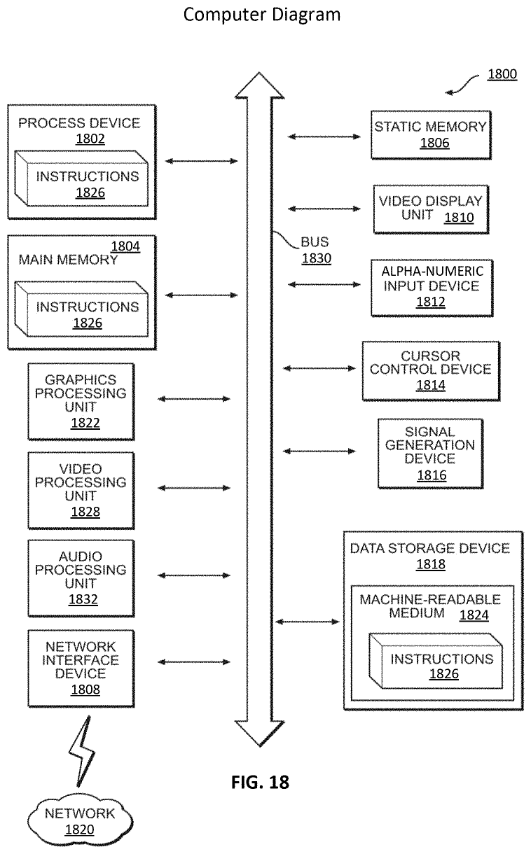

FIG. 18 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1800 includes a processing device 1802, a main memory 1804 (e.g., read-only memory (ROM), flash memory, dynamic random access memory (DRAM) such as synchronous DRAM (SDRAM) or Rambus DRAM (RDRAM), etc.), a static memory 1806 (e.g., flash memory, static random access memory (SRAM), etc.), and a data storage device 1818, which communicate with each other via a bus 1830.

Processing device 1802 represents one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 1802 is configured to execute instructions 1826 for performing the operations and steps discussed herein.

The computer system 1800 may further include a network interface device 1808 to communicate over the network 1820. The computer system 1800 also may include a video display unit 1810 (e.g., a liquid crystal display (LCD) or a cathode ray tube (CRT)), an alphanumeric input device 1812 (e.g., a keyboard), a cursor control device 1814 (e.g., a mouse), a graphics processing unit 1822, a signal generation device 1816 (e.g., a speaker), graphics processing unit 1822, video processing unit 1828, and audio processing unit 1832.

The data storage device 1818 may include a machine-readable storage medium 1824 (also known as a computer-readable medium) on which is stored one or more sets of instructions or software 1826 embodying any one or more of the methodologies or functions described herein. The instructions 1826 may also reside, completely or at least partially, within the main memory 1804 and/or within the processing device 1802 during execution thereof by the computer system 1800, the main memory 1804 and the processing device 1802 also constituting machine-readable storage media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A system comprising one or more processors, and a non-transitory computer-readable medium including one or more sequences of instructions that, when executed by the one or more processors, cause the system to perform operations comprising:
determining a suggested product, based on a respective product located in an electronic records database for display, via a user interface, for a first user account;
displaying, via the user interface, a representation of the suggested product, the representation including a graphical image of the suggested product and a description of the suggested product;
displaying, via the user interface, a selectable functionality to indicate whether the first user account would like to try the suggested product;
receiving, via the user interface, a user input selection for the first user account indicating a confirmation that the first user would like to try the suggested product;
matching the first user account and a second user account for the suggested product where the respective user accounts include indications that both user accounts would like to try the suggested product; and
displaying, via the user interface, for the first user account and indication that a second user account would also like to try the suggested product.

2. The system of claim 1, further comprising the operations of:
sending an electronic notification to the first user account and the second user account indicating a match for the suggested product;
receiving an invite request to the first user account from the second user account that corresponds to the suggested product; and
upon confirmation of the invite acceptance by the first user account, generating an event for the first and second user accounts to try the product at a location of where the product is offered.

3. The system of claim 1, comprising the operations of:
displaying, via the user interface, one or more user accounts, and receiving a selection of the one or more user accounts to create an electronic connection with the one or more user accounts to a first user account.

4. The system of claim 1, wherein the electronic records are generated by the operations comprising:
normalizing multiple electronic records, the electronic records having disparate textual descriptions of products, the normalizing including generating a normalized description representing the disparate textual descriptions of the products.

5. The system of claim 1, wherein the electronic records are generated by the operations comprising:
creating a product normalized database based on a hierarchy of a plurality of product types based in part on at least one of: one or more product components and one or more keywords in the respective menu item name included in the disparate textual descriptions of the products, wherein the disparate textual descriptions of the products originate from multiple, unrelated sources.

6. The system of 5, wherein creating the product normalized database comprises the operations of:
generating the plurality of product types, wherein a respective product type includes one or more products with disparate textual descriptions that share at least one of: one or more menu product component and one or more keywords.

7. The system of claim 6, comprising the operations of:
receiving a rating for the suggested product from at least one of the first and second user accounts, the rating associated with a product event and a ratings placement of the suggested product; and
receiving an experience value for the suggested product of the first user account and the second user account, the experience value includes an indication of having tried the suggested product.

8. A computer-implemented method comprising the operations of:
determining a suggested product, based on a respective product located in an electronic records database for display, via a user interface, for a first user account;
displaying, via the user interface, a representation of the suggested product, the representation including a graphical image of the suggested product and a description of the suggested product;
displaying, via the user interface, a selectable functionality to indicate whether the first user account would like to try the suggested product;
receiving, via the user interface, a user input selection for the first user account indicating a confirmation that the first user would like to try the suggested product;
matching the first user account and a second user account for the suggested product where the respective user accounts include indications that both user accounts would like to try the suggested product; and
displaying, via the user interface, for the first user account and indication that a second user account would also like to try the suggested product.

9. The method of claim 8, comprising the operations of:
sending an electronic notification to the first user account and the second user account indicating a match for the suggested product;
receiving an invite request to the first user account from the second user account that corresponds to the suggested product; and
upon confirmation of the invite acceptance by the first user account, generating an event for the first and second user accounts to try the product at a location of where the product is offered.

10. The method of claim 8, comprising the operations of:
displaying, via the user interface, one or more user accounts, and receiving a selection of the one or more user accounts to create an electronic connection with the one or more user accounts to a first user account.

11. The method of claim 8, wherein the electronic records are generated by the operations comprising:
normalizing multiple electronic records, the electronic records having disparate textual descriptions of products, the normalizing including generating a normalized description representing the disparate textual descriptions of the products.

12. The method of claim 8, wherein the normalized electronic records are generated by the operations comprising:
creating a product normalized database based on a hierarchy of a plurality of product types based in part on at least one of: one or more product components and one or more keywords in the respective menu item name included in the disparate textual descriptions of the products, wherein the disparate textual descriptions of the products originate from multiple, unrelated sources.

13. The method of 12, wherein creating the product normalized database comprises the operations of:
generating the plurality of product types, wherein a respective product type includes one or more products with disparate textual descriptions that share at least one of: one or more menu product component and one or more keywords.

14. The method of claim 13, comprising the operations of:
receiving a rating for the suggested product from at least one of the first and second user accounts, the rating associated with a product event and a ratings placement of the suggested product; and
receiving an experience value for the suggested product of the first user account and the second user account, the experience value includes an indication of having tried the suggested product.

15. A computer program product comprising a non-transitory computer-readable medium having a computer-readable program code embodied therein to be executed by one or more processors, the program code including instructions to perform the operations of:
determining a suggested product, based on a respective product located in a normalized electronic records database for display, via a user interface, for a first user account;
displaying, via the user interface, a representation of the suggested product, the representation including a graphical image of the suggested product and a normalized description of the suggested product;
displaying, via the user interface, a selectable functionality to indicate whether the first user account would like to try the suggested product;
receiving, via the user interface, a user input selection for the first user account indicating a confirmation that the first user would like to try the suggested product;
matching the first user account and a second user account for the suggested product where the respective user accounts include indications that both user accounts would like to try the suggested product; and
displaying, via the user interface, for the first user account and indication that a second user account would also like to try the suggested product.

16. The computer program product of claim 15, comprising the operations of:
sending an electronic notification to the first user account and the second user account indicating a match for the suggested product;
receiving an invite request to the first user account from the second user account that corresponds to the suggested product; and
upon confirmation of the invite acceptance by the first user account, generating an event for the first and second user accounts to try the product at a location of where the product is offered.

17. The computer program product of claim 15, comprising the operations of:
displaying, via the user interface, one or more user accounts, and receiving a selection of the one or more user accounts to create an electronic connection with the one or more user accounts to a first user account.

18. The computer program product of claim 15, wherein the normalized electronic records are generated by the operations comprising:
normalizing multiple electronic records, the electronic records having disparate textual descriptions of products, the normalizing including generating a normalized description representing the disparate textual descriptions of the products.

19. The computer program product of claim 15, wherein the normalized electronic records are generated by the operations comprising:
creating a product normalized database based on a hierarchy of a plurality of product types based in part on at least one of: one or more product components and one or more keywords in the respective menu item name included in the disparate textual descriptions of the products, wherein the disparate textual descriptions of the products originate from multiple, unrelated sources.

20. The computer program product of 19, wherein creating the product normalized database comprises the operations of:
generating the plurality of product types, wherein a respective product type includes one or more products with disparate textual descriptions that share at least one of: one or more menu product component and one or more keywords.

21. The computer program product of claim 20, comprising the operations of:
receiving a rating for the suggested product from at least one of the first and second user accounts, the rating associated with a product event and a ratings placement of the suggested product; and
receiving an experience value for the suggested product of the first user account and the second user account, the experience value includes an indication of having tried the suggested product.
